(19) United States
(12) Patent Application Publication
(10) Pub. No.: US 2013/0327225 A1
(43) Pub. Date: Dec. 12, 2013

(54) Fryer with Removable Filter

(71) Applicants: Pablo Chappell, Bronte (AU); Stephen John McClean, Camden (AU); Tristan Brega, Kyabram (AU); Vyvyan Rose, Vaucluse (AU)

(72) Inventors: Pablo Chappell, Bronte (AU); Stephen John McClean, Camden (AU); Tristan Brega, Kyabram (AU); Vyvyan Rose, Vaucluse (AU)

(73) Assignee: Breville Pty Limited, Botany, NSW (AU)

(21) Appl. No.: 13/878,754

(22) PCT Filed: Oct. 14, 2011
(86) PCT No.: PCT/AU2011/001310

§ 371 Date: Apr. 18, 2013

(30) Foreign Application Priority Data
Oct. 15, 2010 (AU) 2010904603

(51) Int. Cl. A47J 37/12

(52) U.S. Cl. CPC A47J 37/1223
USPC 99/408

(57) ABSTRACT

A deep fryer having a removable electric heating element may incorporate a removable mesh filter below the heating element. Lifting the filter, through the flyer's oil, removes unwanted waste from the oil. In preferred embodiments, a mesh filter is carried by a frame that fits snugly within the interior of the flyer's cooking chamber.

### FIELD OF THE INVENTION

The invention pertains to deep fryers and more particularly to a fryer with a removable filter.

The invention has been developed primarily to a fryer with a removable filter and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Deep fryers are well known in both domestic and commercial applications. The process of deep frying food, particularly battered or crumbed foods results in the production of waste in the form of crumbs or droplets of batter that settle to the bottom of the fryer. When left in the fryer for repeated cooking cycles, the waste (composed largely of carbohydrate) eventually discolours and burns. The burnt cast offs or wastes are unsightly, they discolour the oil and they are considered by some to be a health risk. The present invention addresses the separation of these solid wastes from the cooking oil.

### OBJECTS OF THE INVENTION

It is an object of the present invention to overcome or ameliorate at least one of the disadvantages of the prior art, or to provide a useful alternative.

It is an object of the invention in a preferred form to provide a waste separation filter for a deep fryer.

It is another object of the invention in a preferred form to provide a deep fryer having a removable waste separation filter.

### SUMMARY OF THE INVENTION

According to an aspect of the invention there is provided an electric deep fryer device, comprising:
a cooking container with interior walls, adapted to hold a quantity of heated cooking oil;
a removable filter comprising a frame that supports a mesh filter;
the frame fitting within an interior of the container;
the frame having at least one handle for lifting it from the container, the at least one handle having an upright that extends above the container when the frame is in use.

Preferably, the frame makes sliding contact with the interior walls.

Preferably, the container has within it a removable heating element positioned above the filter, when the filter is in use.

Preferably, the filter is provided with one or more handles, each handle having a grip portion and one or more uprights that are long enough that each grip is positioned above an upper rim of the container when the filter is in use. More preferably, at least one of the handles has a pivoting attachments to the frame for folding inward.

Preferably, the frame has peripheral edges that are resiliently biased outward.

Preferably, the container has a sump into which the frame is insertable. More preferably, the sump is surrounded by inclined inner walls.

Preferably, the frame further comprises uninterrupted sidewalls that enclose a volume of oil and channel that volume through the mesh when the filter is removed. More preferably, each of the sidewalls extends from adjacent to the mesh, to close to an operational oil level, when the filter is in use.

Preferably, the filter is corrugated.

### BRIEF DESCRIPTION OF THE DRAWING FIGURES

In order that the invention be better understood, reference is now made to the following drawing figures in which:

FIG. 1 is an exploded perspective view of a deep fryer incorporating a removable waster filter;

FIG. 2 is a cross section through the filter depicted in FIG. 1;

FIG. 3 is a cross section of a second embodiment of a removable waste filter;

FIG. 4 is a cross sectional diagram of a third embodiment of a removable waste filter;

FIG. 5 is a cross sectional diagram of a fourth embodiment of a removable waste filter;

FIG. 6 is a schematic cross section of a deep fryer;

FIG. 7 is a schematic cross sectional detail of the upper rim of a deep fryer and its lid;

FIG. 8 is a schematic cross section of a second embodiment of a deep fryer incorporating a well or sump;

FIG. 9 an exploded perspective view of a further embodiment of the invention; and

FIG. 10 is a cross sectional view of an alternate waste filter screen.

### BEST MODE AND OTHER EMBODIMENTS

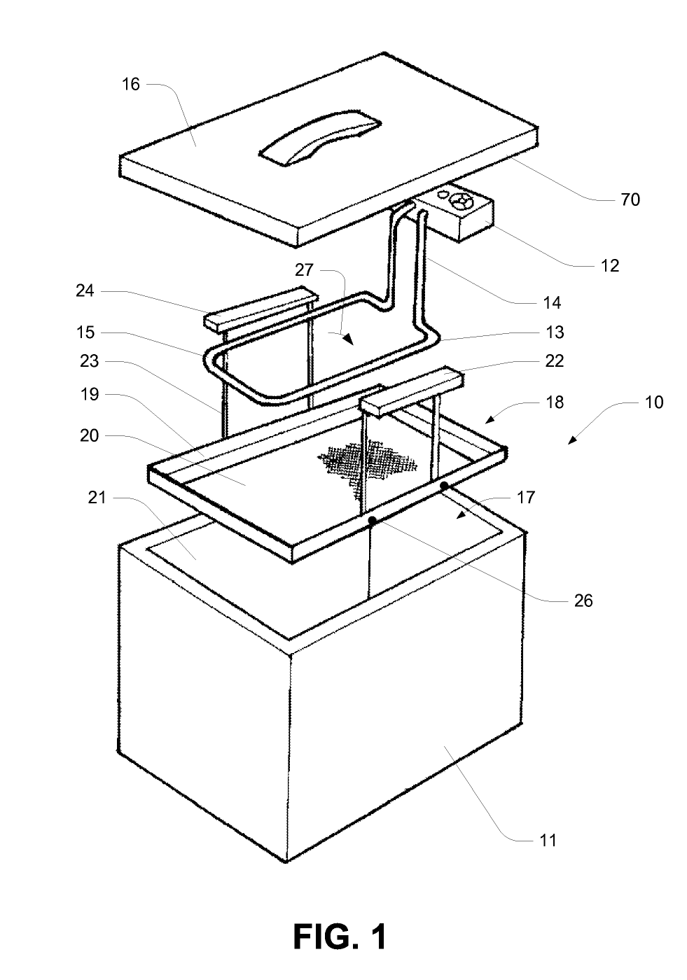

As shown in FIG. 1, an electric deep fryer 10 comprises a cooking container 11 that is adapted to hold a quantity of hot cooking oil. Conventionally, the deep fryer 10 further comprises a removable controller 12 to which is attached an electric heating element 13. In alternate embodiments, the electric heating element 13 may be removed from the cooking container 11, even when the controller 12 is not removable. Removal of the electric heating element 13 is an advantage because it allows for easy removal of the filter apparatus 18 via the main end opening of the container 11. The submergible and preferably removable heating element 13 further comprises two descending limbs 14 and an extended portion 15 that is in a plane parallel to the bottom of the container 11. In some embodiments the element 13 is outside of the container 11 and thus need not be removable. A deep fryer may also incorporate a lid 16 that covers the upper opening 17 of the container. In conventional deep fryers, the lid 16 is relatively loose fitting and does not provide an effective air seal.

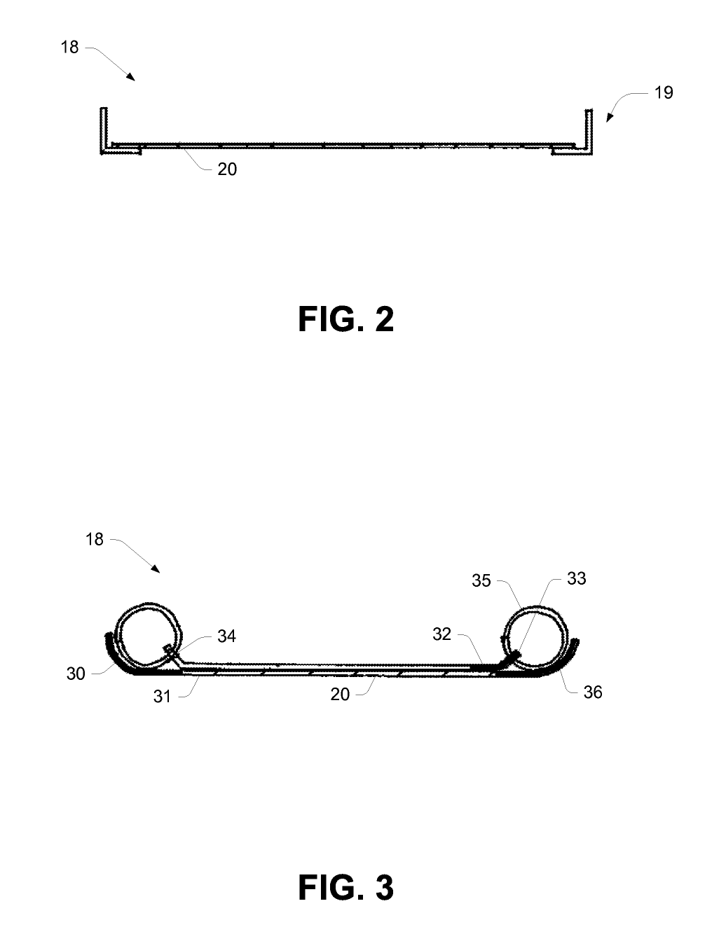

In accordance with FIG. 2 and the teachings of the present invention, the deep fryer 10 is provided with a removable filter apparatus 18. In the example of FIG. 1, the filter apparatus 18 comprises a perimeter frame 19 that supports a stainless steel mesh filter 20. In preferred embodiments, the frame 19 fits snugly within the interior of the container 11. The perimeter frame 19 makes uniform sliding contact with the interior walls 21 of the container. Ideally, any gap between the perimeter frame 19 and the inner walls 21 is small enough that solid waste particles thrown off by the cooking foods are generally unable to pass between the frame 19 and the inner walls 21 of the container 11. In this way, the particles are trapped on the upper surface of the is mesh screen 20. The frame and mesh of the filter 18 are positionable above the inner floor of the container 11 and below heating element 13.

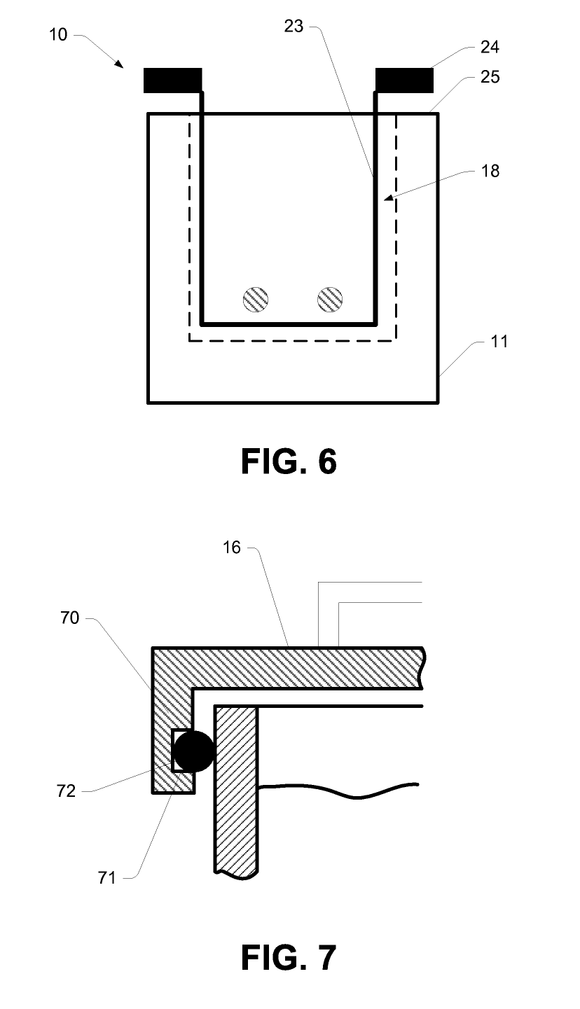

In order to facilitate insertion and removal of the filter 18, the filter 18 is provided with one or more handles 22. In this example, the handles each comprise one or more uprights 23 that are preferably attached to a grip 24. As shown in FIG. 6 the uprights 23 are long enough that the grips 24 are positioned above the upper rim 25 of the container 11 when the filter 18 is in its lower-most inserted position. This allows the filter to be easily removed by the user without requiring the user's fingers to enter the open mouth 17 of the container 11. In this example, the handles are positioned on the long sides of a rectangular filter, the handles opposing one another and being located centrally along each of the long sides for proper balance. For better compactness, particularly for insertion into a dishwasher, the uprights of the handles may have pivoting attachments 26 to the frame 19 so that they can be folded inward 27 so as to rest closely adjacent to the mesh screen 20.

As suggested by FIG. 1, the external dimensions of the filter 18 conform closely to the internal dimensions of the container 11. The container 11 and its cooperating filter apparatus 18 may be of any practical shape such as square, rectangular or round etc.

In order to minimise the gap between the external perimeter of the filter 18 and the interior walls 21 of the container 11, the peripheral edges of the filter 18 may be resiliently biased outward.

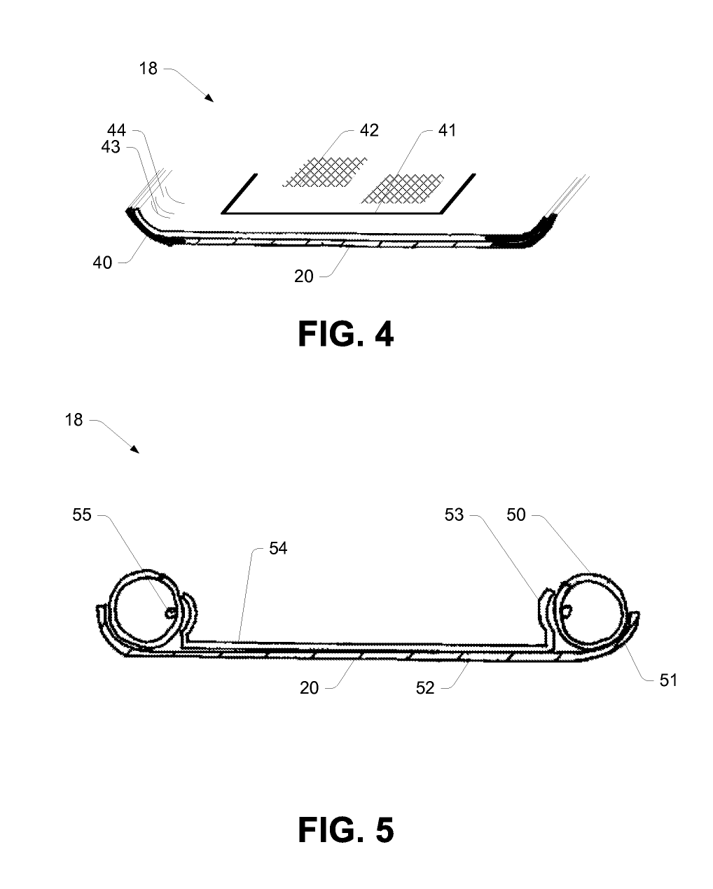

The resilient bias of the outer edge of the filter 18 can be accomplished in a number of different ways. The example provided in FIG. 3 illustrates a filter construction that is analogous to the filter construction of a conventional French press coffee maker. Accordingly, the filter 18 comprises a thin peripheral stainless steel frame 30 to which is attached (for example by welding) a stainless steel wire mesh screen or filter element 31. A second inner or upper frame 32 may be attached to the filter above the mesh 31. This second frame 32 comprises a peripheral edge 33 that is curved up to be raised above the upper surface of the mesh and first frame 30, 31. The raised edge 33 is perforated with regularly spaced holes 34. A stainless steel coil 35 is wound through the holes 34 and is thus retained. The stainless steel coil 35 flexes and helps to maintain the shape of the bend radius 36 of the first frame 30 and exerts a mild counter-force against the terminal edge of the frame 30. The coil 35 allows the radiused portion 36 to flex slightly when inserted into the interior of the container 11 yet does not interfere excessively with the insertion or removal of the filter 18. As shown in FIG. 4, the mild outward restorative force against the radiused portion 40 of the mesh's frame can be exerted by a flexible second or upper frame 41 that lies above the mesh 42. This thin, stainless steel upper frame may be provided with an array of peripheral slots 43 that define flexible fingers 44 that extend upwardly and away from the centre of the mesh 42. The fingers 44 press against the radiused portion of the first frame and help maintain uniform contact between the frame and the inner walls 21 of the container 11.

A further embodiment is depicted in FIG. 5. In this embodiment, the stainless steel peripheral coil 50 is positioned between the radiused periphery 51 of the first frame 52 and a concave, upwardly extending peripheral extension 53 of a second or upper frame 54. The concave periphery 53 of the second frame and the radiused portion 51 of the first frame and the radiused portion 51 of the first frame define a means of mechanically retaining the coil 50 without the need for holes 34. This retention can be assisted by a loop of wire or polymer 55 that is located within the coil. The retainer 55 extends completely around the concave portion 53, but is located within the coil 50. It is used to urge the coil against the concave portion 53 in a way that prevents from being easily removed from its retained location.

In use, the filter apparatus 18 is first inserted into the container 11. The and heating element 14 is then attached to the container or its controller with the heating element 15 being located above the filer 18. Cooking proceeds in the normal manner. After cooking and while the oil is preferably still warm, or heating element 13 is removed (if it is in the oil) and then the filter 18 is then removed. Because the oil is still warm and not overly viscous, the cooking oil will drain through the fine mesh filter 20 whereby solid cooking wastes ejected from the food are trapped on the upper surface of the filter 18. In preferred embodiments, the entire filter apparatus 18 can be placed for cleaning into a sink or dishwasher. As previously mentioned, the handles 22 can be folded flat so that the filter is more compact.

When the cooking waste is removed from the cooking oil by the removal of the filter 18, the remaining cooking oil can be stored in the container 11. To minimise the cooking oil coming into contact with the air, the lid 16 may be provided with a seal, as shown in FIG. 7. As illustrated in FIG. 7, a descending rim 70 of the lid 16 may be provided with an inward facing peripheral groove 71 in which is located a polymeric seal 72. In other embodiments, the entire lid is polymeric and comprises sealing features that are adapted to engage with either the outer or inner walls of the container 11.

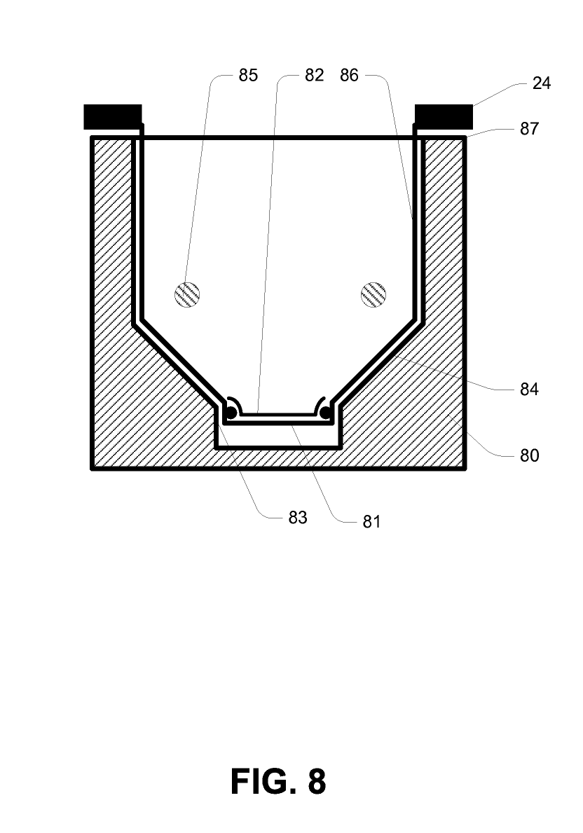

An alternate embodiment of a container and filter arrangement is shown in FIG. 8. In this embodiment, the interior of the cooking container 80 comprises a central sump or well 81 into which the filter frame and mesh arrangement is insertable. The periphery of the filter frame and mesh arrangement 82 contacts the inner walls 83 of the well or sump 81. The well 81 is surrounded by slanted or inclined inner walls 84. Food waste solids fall down the walls 84 and collect on the filter that resides within the well. As previously mentioned, the heating element 85 resides above the filter. The uprights 86 of the filter's handles are shaped to conform to the interior shape of the container 80. As previously mentioned, the handles 24 that are attached to the conformal uprights 86 are preferably located above the upper rim 87 when the filter is inserted. This arrangement allows the size and cost of the filter to be reduced.

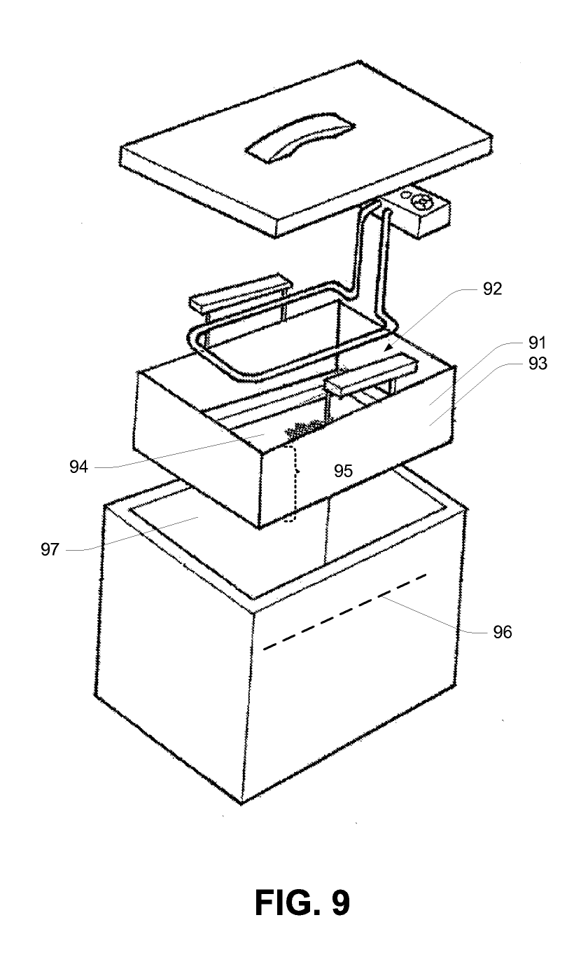

A further embodiment of the invention is depicted in FIG. 9. All of the previous teachings and inter workings of features are previously disclosed are applicable to this embodiment. However, in place of the mechanical sealing arrangements disclosed, for example, in FIGS. 4, 5 and 6, a frame 91 for the filter apparatus 92 comprises continuous and uninterrupted side walls 93 that enclose a substantial volume of oil and channel that volume through the mesh or filter 94 when the filter apparatus is removed. In this embodiment, the height 95 of each of the side walls is such that a side wall extends from adjacent to the mesh 94 or close to the operational oil level 96 when the filter apparatus is installed. Because the bulk of the oil is channelled by the side walls through the filter 94 upon removal of the filter apparatus, seals are not required (but may be used) between the side walls and the interior of the container 97.

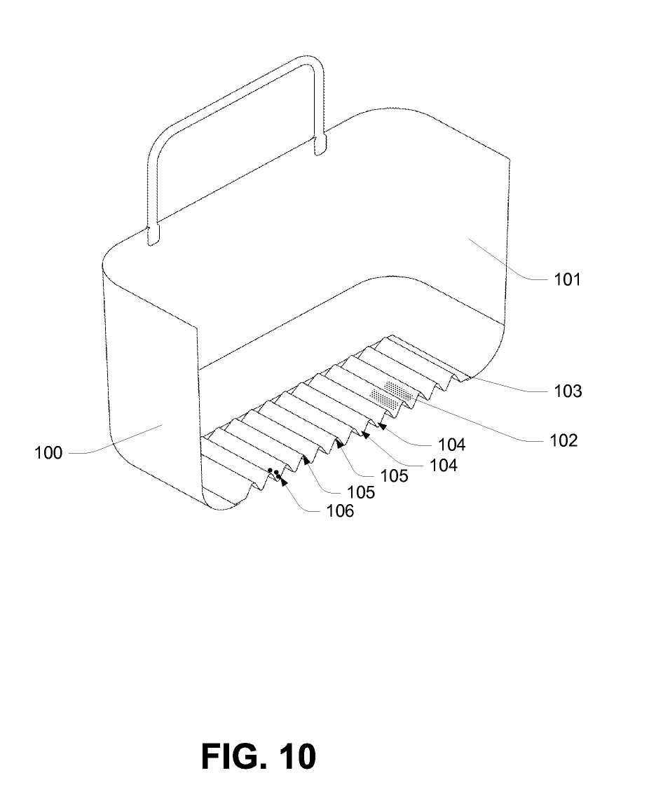

As shown in FIG. 10, a perimeter frame 100 of a removable filter apparatus 101 can support a corrugated mesh filter 102. The corrugated mesh filter 102 may be fabricated from stainless steel and attached to the perimeter frame 100 in any of the ways previously discussed, for example, by affixing a flattened perimeter flange 103 of the mesh filter 102 to the inner periphery of the frame 100. The corrugated mesh 102 may be interchanged with any of the flat mesh filters disclosed with reference to any of the previous embodiments. The purpose of the corrugated mesh is to use the combined forces of gravity and flow through the mesh to trap waste particles in the valleys 104 that exists between the peaks 105 of the mesh filter. Because the waste particles 106 are collected in concentrated (for example, by gravity) in the area of the valleys 104, such particles 106 do not obstruct the mesh in the area of the peaks 105. Thus, the flow through the mesh filter, during removal, is improved. Further, the corrugated construction creates additional surface area for the oil to pass through when the filter is removed.

It will be appreciated that the illustrated embodiment apparatus can provide waste separation filter for a deep fryer. The waste separation filter being preferably removable.

While the present invention has been disclosed with reference to particular details of construction, these should be understood as having been provided by way of example and not as limitations to the scope or spirit of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

As used herein, unless otherwise specified the use of terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader, or with reference to the orientation of the structure during nominal use, as appropriate. Similarly, the terms “inwardly” and “outwardly” generally refer to the orientation of a surface relative to its axis of elongation, or axis of rotation, as appropriate.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An electric deep fryer device, comprising:
a cooking container with interior walls, adapted to hold a quantity of heated cooking oil;
a removable filter comprising a frame that supports a mesh filter;
the frame fitting within an interior of the container;
the frame further comprising an uninterrupted sidewalls that enclose a volume of oil;
wherein removal of the filter channels the volume of oil through the mesh.

2. The device according to claim 1, wherein:
the frame makes sliding contact with the interior walls.

3. The device according to claim 1, wherein:
the container has within it a removable heating element positioned above the filter, when the filter is in use.

4. The device according to claim 1, wherein:
the filter is provided with one or more handles, each handle having a grip portion and one or more uprights that are long enough that each grip is positioned above an upper rim of the container when the filter is in use.

5. The device according to claim 4, wherein:
at least one of the handles has a pivoting attachments to the frame for folding inward.

6. The device of according to claim 2, wherein:
the frame has peripheral edges that are resiliently biased outward.

7. The device according to claim 1, wherein:
the container has a sump into which the frame is insertable.

8. The device according to claim 7, wherein:
the sump is surrounded by inclined inner walls.

9. (canceled)

10. The device according to claim 7, wherein:
each of the sidewalls extends from adjacent to the mesh, to close to an operational oil level, when the filter is in use.

11. The device according to claim 1, wherein:
the filter is corrugated.

12. The device of claim 1, wherein:
each of the sidewalls extends from adjacent to the mesh, to close to an operational oil level, when the filter is in use.

13. The device according to claim 12, wherein:
the filter is corrugated.

14. The device according to claim 12, wherein the frame has at least one handle for lifting it from the container.

15. The device according to claim 14, where at least one handle has an upright that extends above the container when the frame is in use.

16. The device according to claim 12, wherein:
the frame makes sliding contact with the interior walls.

17. The device according to claim 12, wherein:
the container has within it a removable heating element positioned above the filter, when the filter is in use.

18. The device of according to claim 12, wherein:
the frame has peripheral edges that are resiliently biased outward.

19. The device according to claim 13, wherein:
the container has a sump into which the frame is insertable.

20. The device according to claim 19, wherein:
the sump is surrounded by inclined inner walls.
